(19) United States
(12) Patent Application Publication
(10) Pub. No.: US 2026/0236566 A1
(43) Pub. Date: Aug. 13, 2026

(54) SECURE CONTENT ACCESS WITH CRYPTOGRAPHIC KEY AUTHENTICATION

(71) Applicant: MASTERCARD INTERNATIONAL INCORPORATED, Purchase, NY (US)

(72) Inventors: Kaushal SHETTY, O'fallon, MO (US); Mayank JOSHI, Pune (IN); Sachin Kumar SINGH, Pune (IN)

(73) Assignee: MASTERCARD INTERNATIONAL INCORPORATED, Purchase, NY (US)

(21) Appl. No.: 19/051,893

(22) Filed: Feb. 12, 2025

(51) Int. Cl. G06F 21/31; H04L 9/32

(52) U.S. Cl. CPC G06F 21/31; H04L 9/321

(57) ABSTRACT

A process includes receiving, from a first client computing device, a content request for content provided by a content provider computing device. In response to determining that a user credential of a first user of the first client computing device associated with the content request is valid, the process includes obtaining the content identified in the content request from the content provider computing device. The first client computing device and first authentication information associated with the first user is authenticated via an authentication computing device. In response to the first client computing device and the first authentication information associated with the user being valid, the process provides access to the content at the first client computing device.

### BACKGROUND

Data leaks on the dark web, resulting from breaches and malicious activities, expose sensitive user information, leading to various cybercrimes such as identity theft and financial fraud. Traditional methods of protecting confidential documents, files, videos, audio files, or other content, particularly those employing static passwords, are insufficient in preventing unauthorized access. This presents a significant challenge for issuers and users alike, as demonstrated by the vulnerability of current systems.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram illustrating an example of a content authentication system for securely accessing content, according to some embodiments of the present disclosure;

FIG. 2 is a block diagram illustrating an example of a client computing device of the content authentication system of FIG. 1, in accordance with some embodiments of the present disclosure;

FIG. 3 is a block diagram illustrating an example of a security provider computing device of the authentication system of FIG. 1, in accordance with some embodiments of the present disclosure;

FIG. 4 is a block diagram illustrating an authentication computing device of the authentication system of FIG. 1, in accordance with some embodiments of the present disclosure;

FIG. 5 is a block diagram illustrating a content provider computing device of the authentication system of FIG. 1, in accordance with some embodiments of the present disclosure;

FIG. 6 is a flow chart of a method of authenticating a user for content access, in accordance with some embodiments of the present disclosure;

FIG. 7 is a flow chart of a method of providing guest authentication for content access, accordance with some embodiments of the present disclosure;

FIG. 8A is an example flow diagram illustrating communications of the devices of FIG. 1 during the methods of FIG. 6 and FIG. 7, in accordance with some embodiments of the present disclosure;

FIG. 8B is an example entity relationship diagram of the associations provided by the security provider computing device, in accordance with some embodiments of the present disclosure;

FIG. 9 illustrates an example of a computer system that may be implemented by devices illustrated in FIG. 1, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of content security, data encryption, and cryptography. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

As discussed above, the prevalence of data leaks on the dark web poses a significant threat to individuals and businesses, leading to unauthorized access, identity theft, and financial fraud. Current methods of securing sensitive information, particularly those reliant on static passwords, are vulnerable to exploitation. For example, a customer may receive an email monthly from an institution such as for payment of a service. In some cases, as on financial institutions, third party payment (TTP) service providers, or insurance companies while sending the receipt of payment or confirmation of certain policy, those entities send an attachment in the email mentioning the static password. In many cases, service providers often use the same pattern of static password with last 4 digit of card number. This becomes an easy trap for individuals to lose their personally identifying information (PII) as well as financial data.

To address this issue, systems and methods of the present disclosure proposes a solution leveraging a device-level authentication service such as, for example, fast identity online (FIDO) authentication technology to secure confidential documents. By utilizing device-level FIDO private key mapping and user biometric authentication, the systems and methods of the present disclosure ensure secure access to content, mitigating the risk of unauthorized confidential data exposure. By integrating FIDO authentication at the device level, each content item is associated with a unique private key mapped to the user's device identifier. This ensures that only authorized users can access the content using the designated device, thereby eliminating the vulnerability of static passwords.

Furthermore, the systems and the methods of the present disclosure offer flexibility in managing content access by allowing the primary user to add or remove additional users. New users are required to register for the service, undergo authentication by the primary user, and receive approval before gaining access. This process facilitates secure content sharing while maintaining control over access permissions. Additionally, the number of authorized users can be updated dynamically, ensuring scalability and adaptability to changing user requirements.

Overall, the systems and methods of the present disclosure provide a comprehensive and secure solution to the challenge of safeguarding confidential content in the face of increasing threats from dark web leaks. By leveraging, a device-level authentication system such as FIDO authentication technology and implementing flexible user management features, the systems and the methods of the present disclosure address the limitations of traditional content security methods, thus offering enhanced protection against unauthorized access and data breaches.

Having described examples of system operation, a system environment for a dynamic encryption scheme will now be described.

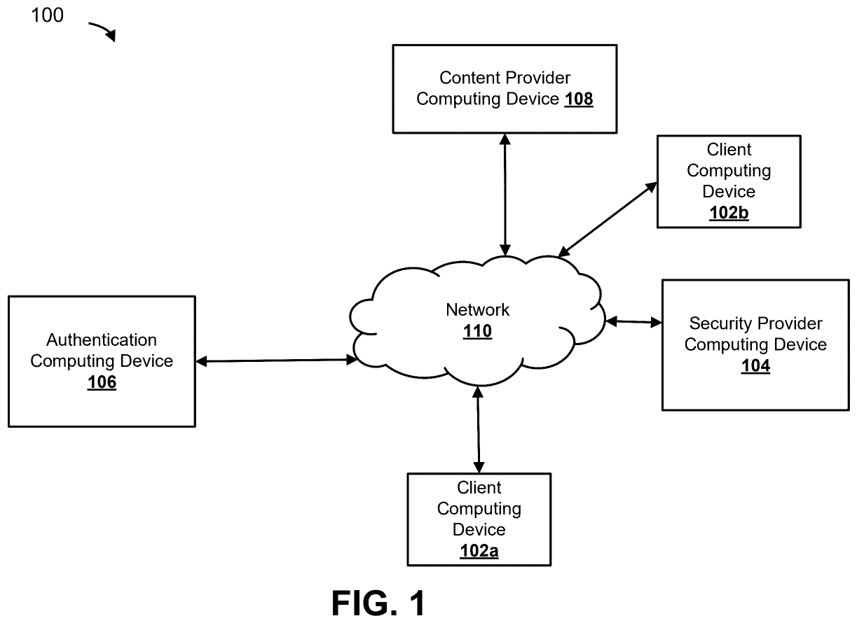

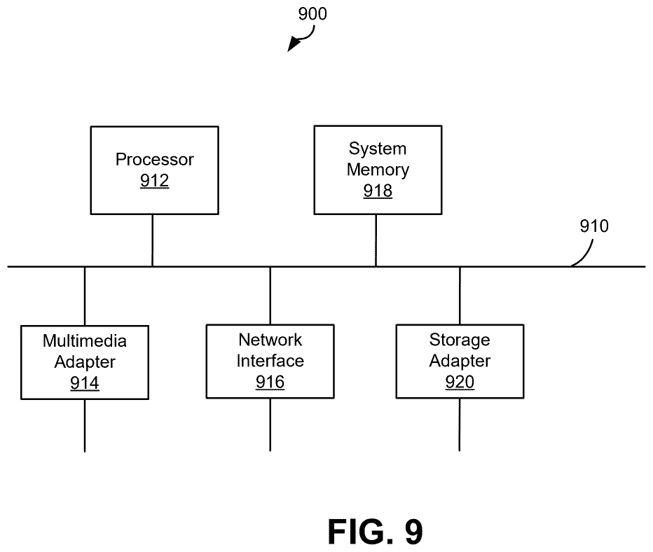

FIG. 1 depicts a block diagram of an example of a content authentication system 100, consistent with some embodiments. In some embodiments, the content authentication system 100 may include a client computing device 102a, a client computing device 102b, a security provider computing device 104, an authentication computing device 106, and a content provider computing device 108. The client computing device 102a, the client computing device 102b, the security provider computing device 104, the authentication computing device 106, and the content provider computing device 108 may be in communication with each other over a network 110. In various embodiments, the client computing device 102a and the client computing device 102b may be associated with a respective user (e.g., in memory of the content authentication system 100 in virtue of user profiles). These various components may be implemented with computing devices like that shown in FIG. 9.

In some embodiments, the client computing device 102a or the client computing device 102b may be implemented using various combinations of hardware or software configured for wired or wireless communication over the network 110. For example, the client computing device 102a and 102b may be implemented as a wireless telephone (e.g., smart phone), a tablet, a personal digital assistant (PDA), a notebook computer, a personal computer, a connected set-top box (STB) such as provided by cable or satellite content providers, or a video game system console, a head-mounted display (HIVID), a watch, an eyeglass projection screen, an autonomous/semi-autonomous device, a vehicle, a user badge, or other user computing devices. In some embodiments, the client computing device 102a and 102b may include various combinations of hardware or software having one or more processors and capable of reading instructions stored on a tangible non-transitory machine-readable medium for execution by the one or more processors. Consistent with some embodiments, the user computing devices 102 and 103 include a machine-readable medium, such as a memory that includes instructions for execution by one or more processors for causing the client computing device 102a and 102b to perform specific tasks. In some embodiments, the instructions may be executed by the one or more processors in response to interaction by the user. In FIG. 1, two user computing device are shown, but commercial implementations are expected to include hundreds, thousands, or than one million, e.g., more than 10 million, geographically distributed over North America or the world.

The client computing device 102a and 102b may include a communication system having one or more transceivers to communicate with other user computing devices, the security provider computing device 104, the authentication computing device 106, or the content provider computing device 108. Accordingly, and as disclosed in further detail below, the client computing device 102a and 102b may be in communication with systems directly or indirectly. As used herein, the phrase “in communication,” and variants thereof, is not limited to direct communication or continuous communication and may include indirect communication through one or more intermediary components or selective communication at periodic or aperiodic intervals, as well as one-time events.

For example, the client computing device 102a and 102b in the content authentication system 100 of FIG. 1 may include first (e.g., relatively long-range) transceiver to permit the client computing device 102a or 102b to communicate with the network 110 via a communication channel. In various embodiments, the network 110 may be implemented as a single network or a combination of multiple networks. For example, in various embodiments, the network 110 may include the Internet or one or more intranets, landline networks, wireless networks, or other appropriate types of communication networks. In another example, the network 110 may comprise a wireless telecommunications network adapted to communicate with other communication networks, such as the Internet. The wireless telecommunications network may be implemented by an example mobile cellular network, such as a long-term evolution (LTE) network or other third generation (3G), fourth generation (4G) wireless network, fifth generation (5G) wireless network or any subsequent generations. In some examples, the network 110 may be additionally or alternatively be implemented by a variety of communication networks, such as, but not limited to (which is not to suggest that other lists are limiting), a satellite communication network, a microwave radio network, or other communication networks.

The client computing devices 102a and 102b additionally may include second (e.g., short-range relative to the range of the first transceiver) transceiver to permit the client computing devices 102a or 102b to communicate with each other or other user computing devices via a direct communication channel. Such second transceivers may be implemented by a type of transceiver supporting short-range (i.e., operate at distances that are shorter than the long-range transceivers) wireless networking. For example, such second transceivers may be implemented by Wi-Fi transceivers (e.g., via a Wi-Fi Direct protocol), Bluetooth® transceivers, infrared (IR) transceivers, and other transceivers that are configured to allow the client computing devices 102a and 102b to communicate with each other or other user computing devices via an ad-hoc or other wireless network.

In various embodiments, the content authentication system 100 may also include or may be in connection with the security provider computing device 104. For example, the security provider computing device 104 may include one or more server devices, storage systems, cloud computing systems, or other computing devices (e.g., desktop computing device, laptop/notebook computing device, tablet computing device, mobile phone, etc.). In various embodiments, security provider computing device 104 may also include various combinations of hardware or software having one or more processors and capable of reading instructions stored on a tangible non-transitory machine-readable medium for execution by the one or more processors. Consistent with some embodiments, the security provider computing device 104 includes a machine-readable medium, such as a memory (not shown) that includes instructions for execution by one or more processors (not shown) for causing the security provider computing device 104 to perform specific tasks. In some embodiments, the instructions may be executed by the one or more processors in response to interaction by the user. The security provider computing device 104 may also be maintained by an entity with which sensitive credentials and information may be exchanged with the client computing devices 102a and 102b. The security provider computing device 104 may further be one or more servers that hosts applications for the client computing devices 102a and 102b. The security provider computing device 104 may provide the security to the content provider computing device 108, the client computing devices 102a and 102b and the authentication computing device 106 by acting as an intermediary between the various devices in the content authentication system 100 by obtaining the content from the content provider computing device 108, verifying a user of the client computing device 102a or 102b, authenticating the user and client computing device with the authentication computing device 106, and providing the content to the client computing device 102a or 102b that is authenticated and that is operated by the verified and authenticated user as wells as other processes discussed in more detail below.

In various embodiments, the content authentication system 100 may also include or may be in connection with the authentication computing device 106. For example, the authentication computing device 106 may include one or more server devices, storage systems, cloud computing systems, or other computing devices (e.g., desktop computing device, laptop/notebook computing device, tablet computing device, mobile phone, etc.). In various embodiments, authentication computing device 106 may also include various combinations of hardware or software having one or more processors and capable of reading instructions stored on a tangible non-transitory machine-readable medium for execution by the one or more processors. Consistent with some embodiments, the authentication computing device 106 includes a machine-readable medium, such as a memory (not shown) that includes instructions for execution by one or more processors (not shown) for causing the authentication computing device 106 to perform specific tasks. In some embodiments, the instructions may be executed by the one or more processors in response to interaction by the user. The authentication computing device 106 may also be maintained by an entity with which sensitive credentials and information may be exchanged with the client computing devices 102a and 102b or the security provider computing device 104. The authentication computing device 106 may provide device-level authentication to the client computing devices 102a and 102b by providing a device-level authentication protocol such as FIDO, which may be performed before access to the content is granted.

In various embodiments, the content authentication system 100 may also include or may be in connection with the content provider computing device 108. For example, the content provider computing device 108 may include one or more server devices, storage systems, cloud computing systems, or other computing devices (e.g., desktop computing device, laptop/notebook computing device, tablet computing device, mobile phone, etc.). In various embodiments, the content provider computing device 108 may also include various combinations of hardware or software having one or more processors and capable of reading instructions stored on a tangible non-transitory machine-readable medium for execution by the one or more processors. Consistent with some embodiments, the content provider computing device 108 includes a machine-readable medium, such as a memory (not shown) that includes instructions for execution by one or more processors (not shown) for causing the content provider computing device 108 to perform specific tasks. In some embodiments, the instructions may be executed by the one or more processors in response to interaction by the user. The content provider computing device 108 may provide protected content (e.g., documents, email and attachments, video, audio, or other content or data that would be apparent to one of skill in the art in possession of the present disclosure) that is protected with various encryption schemes using cryptographic keys of a device-level authentication protocol such as FIDO. While a specific content authentication system is illustrated in FIG. 1, one of skill in the art in possession of the present disclosure will recognize that other components and configurations are possible, and thus will fall under the scope of the present disclosure.

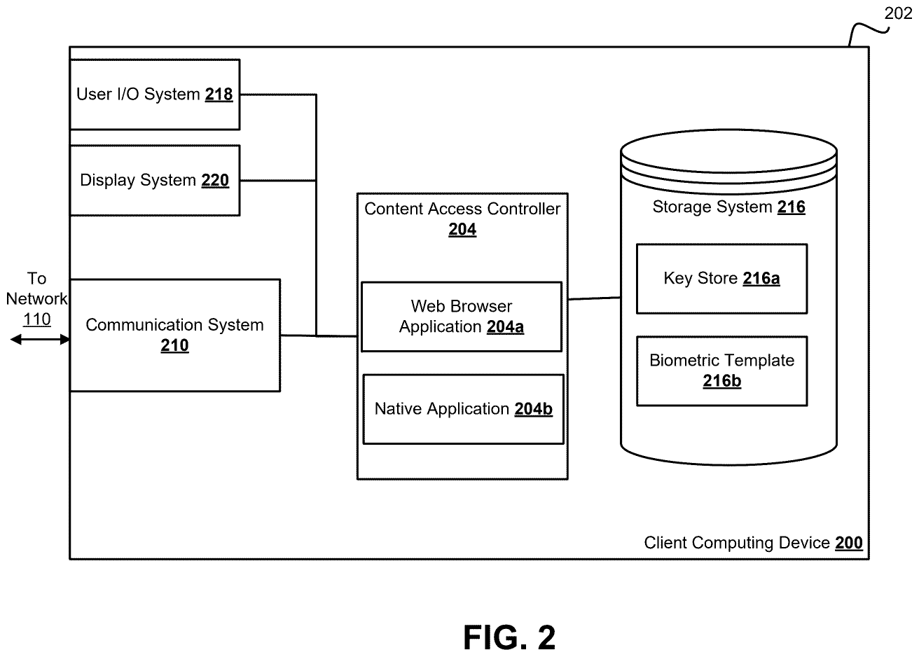

FIG. 2 illustrates an embodiment of a client computing device 200 that may be the client computing device 102a or 102b discussed above with reference to FIG. 1. In the illustrated embodiment, the client computing device 200 includes a chassis 202 that houses the components of the client computing device 200. Several of these components are illustrated in FIG. 2. For example, the chassis 202 may house a processing system and a non-transitory memory system that includes instructions that, when executed by the processing system, cause the processing system to provide a content access controller 204 that is configured to perform the functions of the content access controller or the client computing devices, discussed below. In the specific example illustrated in FIG. 2, the content access controller 204 is configured to provide one or more of a web browser application 204a or a native application 204b.

The chassis 202 may further house a communication system 210 that is coupled to the content access controller 204 (e.g., via a coupling between the communication system 210 and the processing system). The communication system 210 may include software or instructions that are stored on a computer-readable medium and that allow the user computing device 200 to send and receive messages through the communication networks discussed above. For example, the communication system 210 may include a communication interface to provide for communications through the network 110 as detailed above (e.g., first (e.g., long-range) transceiver). In an embodiment, the communication interface may include a wireless antenna that is configured to provide communications with IEEE 802.11 protocols (Wi-Fi), cellular communications, satellite communications, other microwave radio communications or communications. The communication system 210 may also include a communication interface (e.g., the second (e.g., short-range) transceiver) that is configured to provide direct communication with other user computing devices, sensors, storage devices, beacons, and other devices included in the securitization system discussed above with respect to FIG. 1. For example, the communication interface may include a wireless antenna that configured to operate according to wireless protocols such as Bluetooth®, Bluetooth® Low Energy (BLE), near field communication (NFC), infrared data association (IrDA), ANT®, Zigbee®, Z-Wave® IEEE 802.11 protocols (Wi-Fi), or other wireless communication protocols that allow for direct communication between devices.

The chassis 202 may house a storage device (not illustrated) that provides a storage system 216 that is coupled to the content access controller 204 through the processing system. The storage system 216 may be configured to store data, applications, a key store 216a (e.g., private or public keys), biometric templates 216b, or instructions described in further detail below and used to perform the functions described herein. In various embodiments, the chassis 202 also houses a user input/output (I/O) system 218 that is coupled to the content access controller 204 (e.g., via a coupling between the processing system and the user I/O system 218). In an embodiment, the user I/O system 218 may be provided by a keyboard input subsystem, a mouse input subsystem, a track pad input subsystem, a touch input display subsystem, a microphone, an audio system, a haptic feedback system, or any other input subsystem. The chassis 202 also houses a display system 220 that is coupled to the content access controller 204 (e.g., via a coupling between the processing system and the display system 220) and may be included in the user I/O system 218. In some embodiments, the display system 220 may be provided by a display device that is integrated into the user computing device 200 and that includes a display screen (e.g., a display screen on a laptop/notebook computing device, a tablet computing device, a mobile phone, or wearable device), or by a display device that is coupled directly to the user computing device 200 (e.g., a display device coupled to a desktop computing device by a cabled or wireless connection).

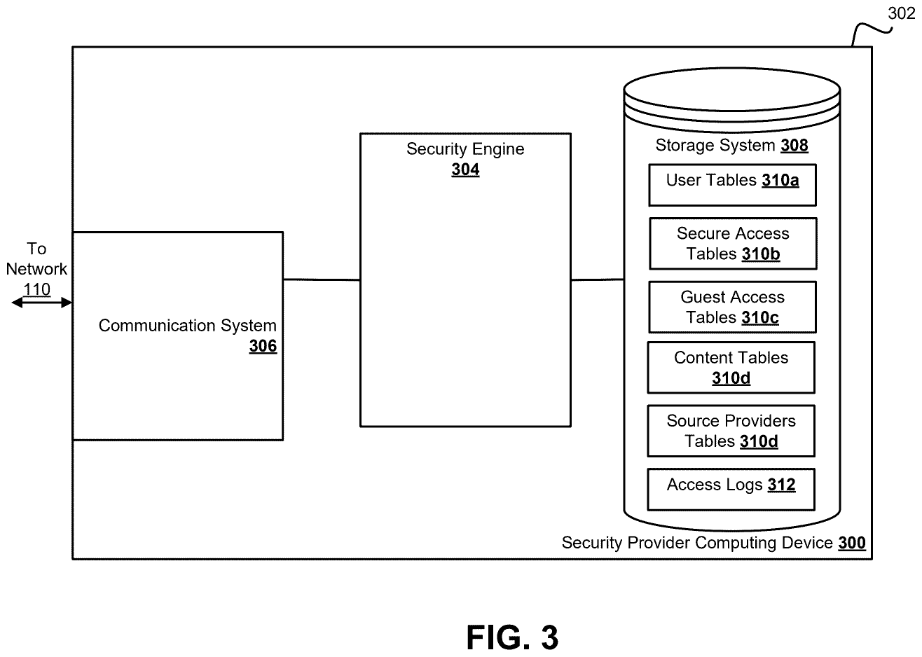

FIG. 3 depicts an embodiment of a security provider computing device 300, which may be the security provider computing device 104 discussed above with reference to FIG. 1. In the illustrated embodiment, the security provider computing device 300 includes a chassis 302 that houses the components of the security provider computing device 300, only some of which are illustrated in FIG. 3. For example, the chassis 302 may house a processing system (not illustrated) and a non-transitory memory system (not illustrated) that includes instructions that, when executed by the processing system, cause the processing system to provide a security engine 304 that is configured to perform the functions of the security engine or security provider computing device discussed below. Specifically, the security engine 304 may verify and authenticate a user of a client computing device at the device-level and with an authentication computing device such that secure content may be accessed and provided to the user of the client computing device, as discussed in further detail below.

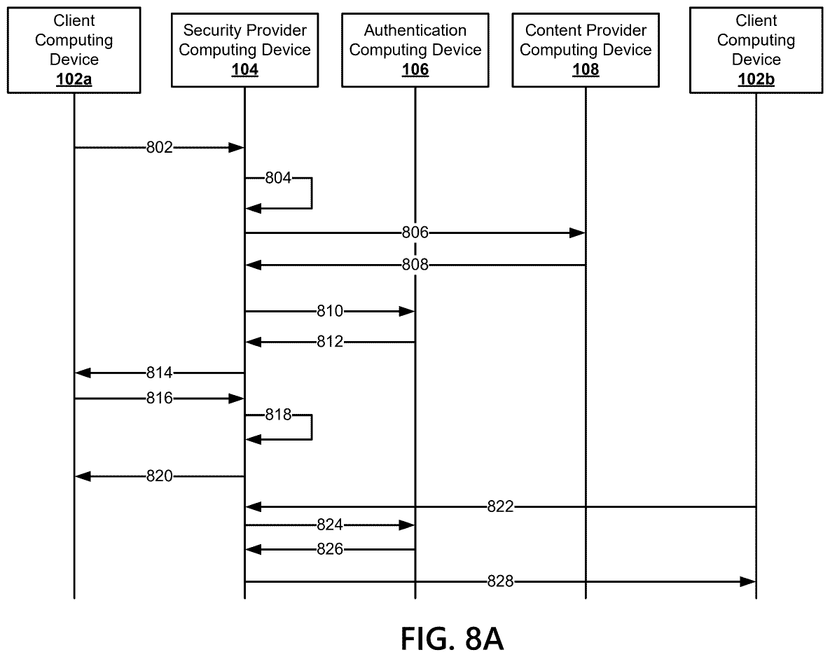

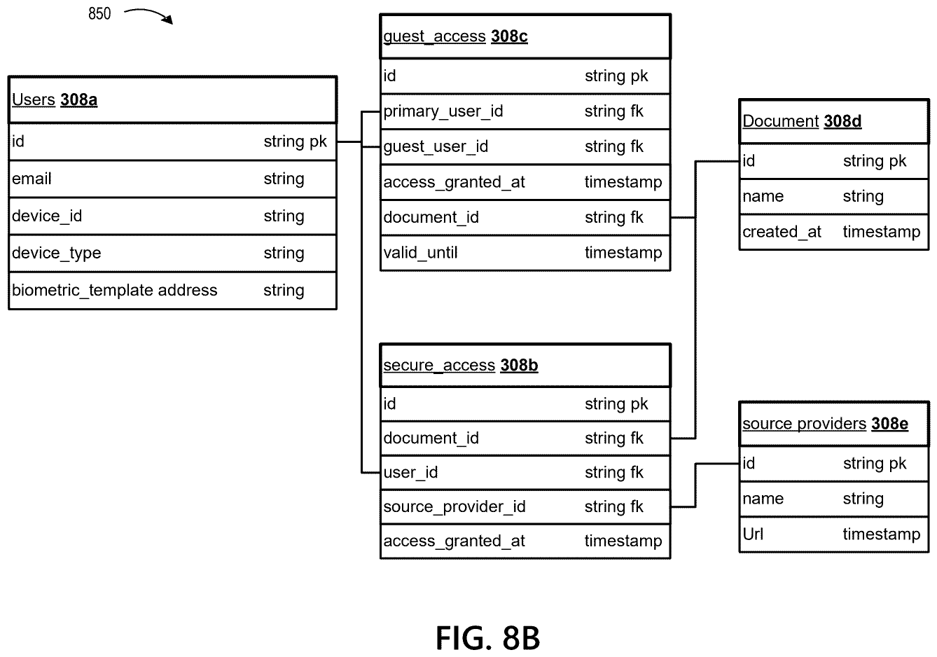

The chassis 302 may further house a communication system 306 that is coupled to the security engine 304 (e.g., via a coupling between the communication system 306 and the processing system) and that is configured to provide for communication through the network 110 of FIG. 1 as detailed below. The communication system 306 may allow the security provider computing device 300 to send and receive information and content over the network 110 of FIG. 1. The chassis 302 may also house a storage device (not illustrated) that provides a storage system 308 that is coupled to the security engine 304 through the processing system. The storage system 308 may be configured to store a user table 310a, a secure access table 310b, a guest access table 310c, a content table 310d, a source provider table 310e, and access logs 312. FIG. 8B provides an illustration of the user table 310a, the secure access table 310b, the guest access table 310c, the content table 310d, and the source provider table 310e and how the security engine 304 establishes relationships or associations between the content and the users. The storage system 308 may include other data or instructions to complete the functionality discussed herein. In various embodiments, the storage system 308 may be provided on the security provider computing device 300 or on a database accessible via the communication system 306. Furthermore, while the security engine 304 is illustrated as being located on the security provider computing device 104/300, the security engine 304 or a portion of its functionality may be included on the client computing devices 102a or 102b of FIG. 1. For example, the security engine 304 may obtain and send content, credentials, or keys via the client computing device 102a rather than receiving and sending them directly.

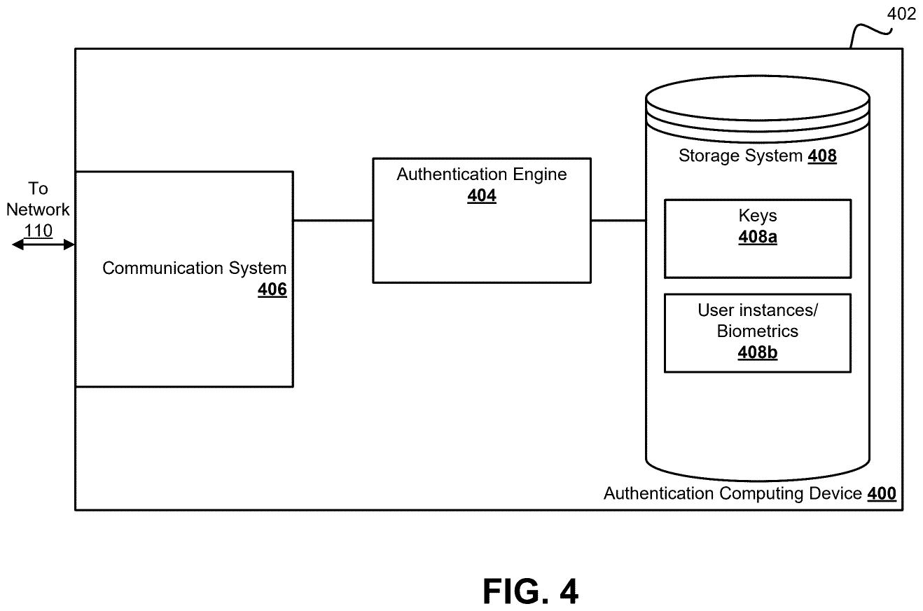

FIG. 4 illustrates an embodiment of an authentication computing device 400 that may be the authentication computing device 106 discussed above with reference to FIG. 1. In the illustrated embodiment, the authentication computing device 400 includes a chassis 402 that houses the components of the authentication computing device 400. Several of these components are illustrated in FIG. 4. For example, the chassis 402 may house a processing system and a non-transitory memory system that includes instructions that, when executed by the processing system, cause the processing system to provide authentication engine 404 that is configured to perform the functions of the authentication engine or the authentication computing device, discussed below.

The chassis 402 may further house a communication system 406 that is coupled to the authentication engine 404 (e.g., via a coupling between the communication system 406 and the processing system). The communication system 406 may include software or instructions that are stored on a computer-readable medium and that allow the authentication computing device 400 to transfer keys and messages through the communication networks discussed above. For example, the communication system 406 may include a communication interface to provide for communications through the network 110 as detailed above.

The chassis 402 may house a storage device (not illustrated) that provides a storage system 408 that is coupled to the authentication engine 404 through the processing system. The storage system 408 may be configured to store data, applications, cryptographic keys 408a, user instances 408b (that may include biometric templates for authentication of a user), or instructions described in further detail below and used to perform the functions described herein. While a specific example of an authentication computing device is illustrated, one of skill in the art in possession of the present disclosure will recognize that different configurations may be contemplated.

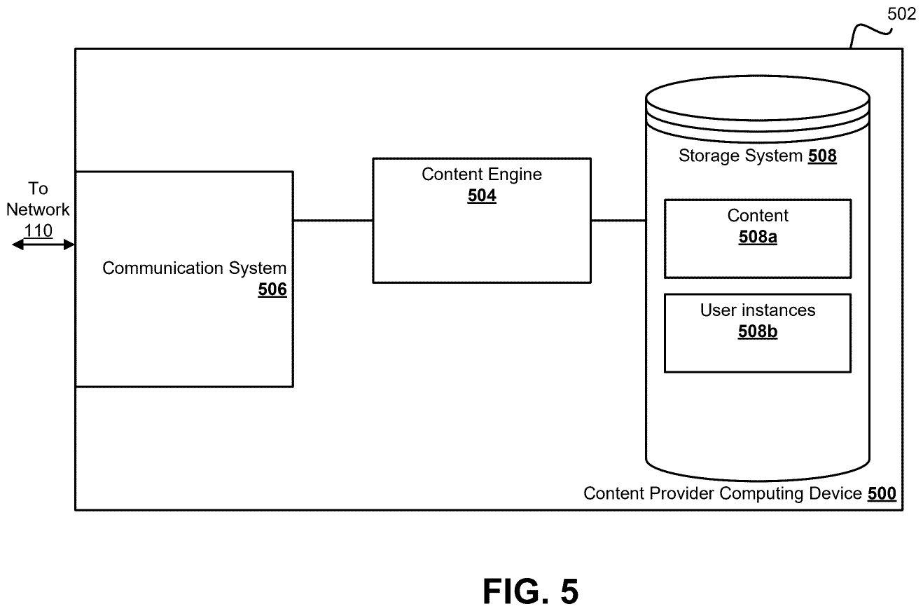

FIG. 5 illustrates an embodiment of a content provider computing device 500 that may be the content provider computing device 108 discussed above with reference to FIG. 1. In the illustrated embodiment, the content provider computing device 500 includes a chassis 502 that houses the components of the content provider computing device 500. Several of these components are illustrated in FIG. 5. For example, the chassis 502 may house a processing system and a non-transitory memory system that includes instructions that, when executed by the processing system, cause the processing system to provide content provider engine 504 that is configured to perform the functions of the content provider engine or the content provider computing device, discussed below.

The chassis 502 may further house a communication system 506 that is coupled to the content provider engine 504 (e.g., via a coupling between the communication system 506 and the processing system). The communication system 506 may include software or instructions that are stored on a computer-readable medium and that allow the content provider computing device 500 to transfer keys and messages through the communication networks discussed above. For example, the communication system 506 may include a communication interface to provide for communications through the network 110 as detailed above.

The chassis 502 may house a storage device (not illustrated) that provides a storage system 508 that is coupled to the content provider engine 504 through the processing system. The storage system 508 may be configured to store data, content 508a, user instances 508b, or instructions described in further detail below and used to perform the functions described herein. While a specific example of a content provider computing device is illustrated, one of skill in the art in possession of the present disclosure will recognize that different configurations may be contemplated.

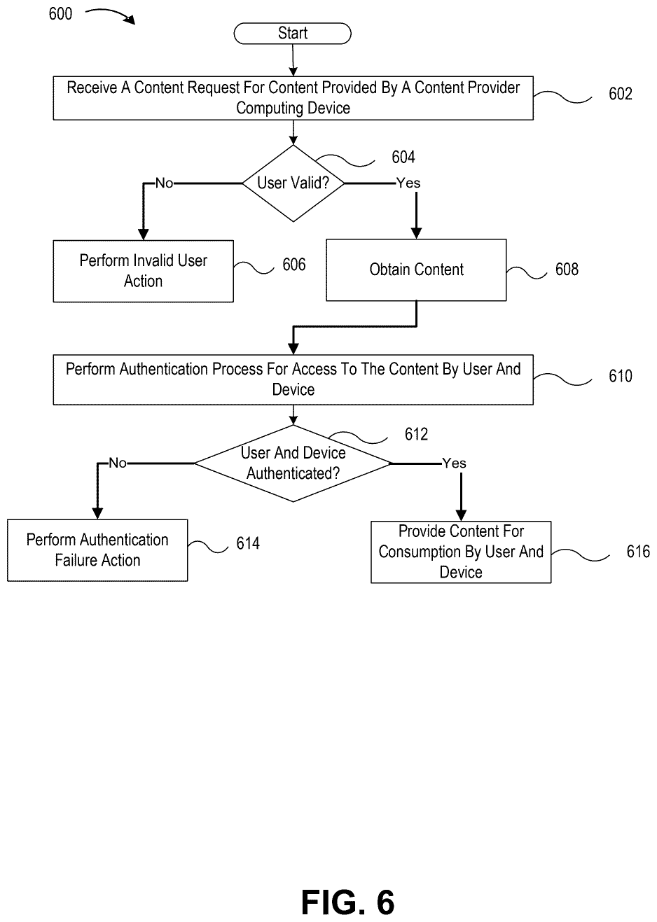

FIG. 6 depicts an embodiment of a method 600 of content access authentication, which in some embodiments may be implemented with the components of FIGS. 1, 2, 3, 4, and 5 discussed above. As discussed herein, some embodiments make technological improvements to content management systems, encryption and decryption, and other computer-centric technology. In a variety of scenarios, the systems and methods of the present disclosure may be useful to access content more securely and without static passwords. One of skill in the art in possession of the present disclosure will recognize that Internet-centric and content management problems, along with other computer-centric problems, are solved or mitigated by some of these embodiments. Again, though, embodiments are not limited to approaches that address these problems, as various other problems may be addressed by other aspects of the present disclosure, which is not to suggest that any other description is limiting.

The method 600 may include block 602 where a content request for content provided by a content provider computing device is received. In an embodiment, at block 602, the content access controller 204 of the client computing device 102a may receive an input from a user via the user I/O system 218. The content access controller 204 may include the native application 204b or the web browser application 204a that interfaces with the security provider computing device 104/300. Rather than directly requesting the content from the content provider computing device 108/500, the content provider may be registered with the security provider such that the user interfaces with the security provider to access the content provider's service. Alternatively, the user may interact with a content provider's website or native application and that content provider may make an API call to the security provider computing device 104/300. As such, the security engine 304 may receive the request content. However, one of skill in the art in possession of the present disclosure will recognize that other configurations would be possible between the client computing device 102a, the security provider computing device 104, and the content provider computing device 108 when making a request for content provided by the content provider computing device 108.

In various embodiments, the content request may include user credentials. For example, prior to requesting content or during the request for content, a user may log in to their user account with the security service provider to verify the user. In some embodiments, and as discussed below, the content access controller 204 may obtain biometric information and perform biometric authentication (e.g., a face scan, facial recognition or the like) in addition to or lieu of the initial verification with the user credentials. The user may then make the content request by searching for the content that the user desires to access through an content management interface provided by the native application 204b or the web browser application 204a, which may include categories, tags, a search bar, or other selectable interface that user may interact with to request access to the content.

The method 600 may proceed to decision block 604 where it is determined whether a user credential associated with the content request is valid. In an embodiment, at decision block 604, the security engine 304 may determine whether the user credential is valid. For example, the security engine 304 may determine whether the user provided user credentials or biometric information match those stored with the security provider computing device 104/300 such that the user's user table of the user tables 310a can be accessed to identify content and content providers that the user is associated with. If, at decision block 604, the user credentials are not valid in that the user credentials do not match a stored user credential, then the method 600 may proceed to block 606 where an invalid event is performed. In an embodiment at block 606, the security engine 304 may provide an unsuccessful login notification in response to an invalid user credential to the client computing device 102a.

If, at decision block 604, the user credentials are valid, then the method 600 may proceed to block 608 where the content identified in the content request is obtained. In an embodiment, at block 608, the security engine 304 may obtain the content identified in the content request from the content provider computing device 500. The security engine 304 may determine whether the user is associated with a guest access table 310c or a secure access table 310b that is associated with the content, if so, the security engine 304 may obtain the content. The security engine 304 may send a request for the content identified in the content request via the network 110 to the content provider computing device 108. The content provider engine 504 of the content provider computing device 108/500 may process the request and provide, via the network 110, the content to the security engine 304. If additional approval is required (e.g., for sensitive documents), an automated request is sent to the necessary approver(s).

The method 600 may proceed to block 610 where the client computing device and authentication information associated with the user is authenticated. In an embodiment, at block 610, the security engine 304 may perform an authentication process with the authentication computing device 106/400 to authenticate the client computing device 102a and the user of the client computing device 102a. For example, the security engine 304 may obtain authentication information from the client computing device 102a for FIDO authentication. FIDO is an open standard for secure, passwordless authentication designed to reduce reliance on traditional passwords while improving security and user convenience. FIDO works by utilizing public-private key cryptography, where the client computing device 102a generates a public-private key pair prior to method 600. The private key remains securely stored on the client computing device 102a in the key store 216a, while the corresponding public key is registered with the authentication computing device 106 (e.g., keys 408a).

In various embodiments, the security engine 304 may send a challenge that the client computing device 102a signs with the private key. The security challenge may be provided by public key information that was associated with the content at the content provider computing device 500 or that was stored for the content with an association at the security provider computing device 104/300. The content provider storage of the public key information may be used when the content provider directly manages key associations for its content. The security provider storage of public key information may be used when the security provider computing device 104/300 acts as a central authority for managing access and keys across multiple content providers.

The signed challenge along with other authentication information such as user biometrics may be provided to the authentication computing device 106/400 to prove the user's identity without transmitting the private key itself and using the corresponding public key. The authentication engine 404 of the authentication computing device 106/400 may then validate the authentication information that includes the user authentication information and the client computing device authentication information. The authentication engine 404 may retrieve the correct public key for validation by querying the security provider computing device 300 and confirm that the retrieved public key corresponds to the user or the requested content. The authentication engine 404 may then return either a validation success response or a validation unsuccessful response in response to the authentication request. This process ensures that even if a hacker intercepts the communication, the hacker cannot access the private key or impersonate the user. FIDO and other device-level passwordless authentication protocols support various authentication methods, including biometrics (e.g., fingerprints, facial recognition) and hardware tokens, providing a versatile, phishing-resistant approach to online authentication.

The method 600 may proceed to decision block 612 where it is determined whether the authentication of the user and client computing device is valid. If, at decision block 612, it is determined that the authentication is invalid, then the method 600 may proceed to block 614, where an invalid authentication action may be performed. For example, the security engine 304 may return a notification to the client computing device 102a/200 that the authentication failed for the requested content and discard the content that was obtained in the request for content.

If, at decision block 612, it is determined that the authentication is valid, then the method 600 may proceed to block 616, where the client computing device is provided access to the content that was requested. In an embodiment, at block 616, the security engine 304 may release the content that was obtained from the content provider computing device 108/500 in response to the content request. The user may consume the content at the client computing device 102a/200 via the user I/O system 218 or the display system 220. The access of the content may include viewing the document directly in the web browser application 204a or native application 204b or downloading the content, depending on permissions. In some embodiments, a watermark with the user's details (e.g., user's name, a timestamp, or the like) may be overlaid on the content to deter misuse. The security engine 304 may log the access event in the access log 312 to ensure traceability.

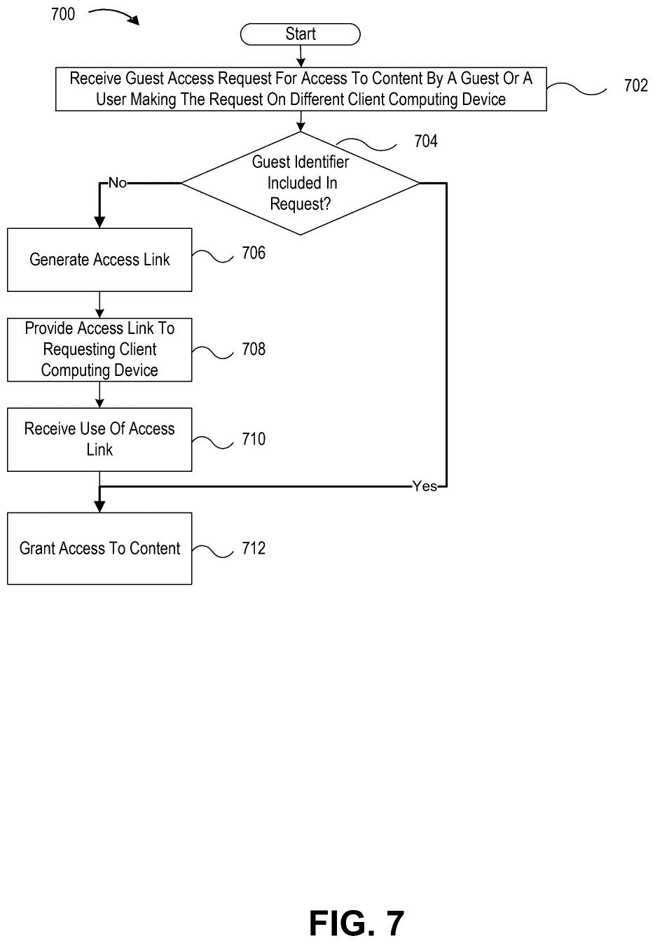

FIG. 7 depicts an embodiment of a method 700 of content access authentication, which in some embodiments may be implemented with the components of FIGS. 1, 2, 3, 4, and 5 discussed above. In some embodiments, method 700 may be an extension of method 600 of FIG. 6 but where a user wants to access the content from a different client computing device such as client computing device 102b or wants to grant access to the content to a different user of the client computing device 102b. The method 700 may begin at block 702 where a guest access request for a second client computing device to access the content is received. In an embodiment, at block 702, the user of the client computing device 102a may generate a guest access request to access content stored at the content provider computing device 108/500. The guest access request may be provided to the security provider computing device 104. The guest access request may include a user identifier of the user of the client computing device 102b if that user is registered with the security provider computing device 104.

The method 700 may proceed to decision block 704 where it is determined whether the guest access request includes the user identifier of the guest user of the guest client computing device. In an embodiment, at decision block 704, the security engine 304 of the security provider computing device 104/300 may determine whether the guest user identifier is included in the guest access request. If, at decision block 704, the guest user identifier is not included in the guest access request, the method 700 may proceed to block 706 where an access link is generated. In an embodiment, at block 706, the security engine 304 may generate an access link in response to the guest user identifier not being included in the guest access request for the content. The access link may include a content identifier that is associated with the content. In some embodiments, the access link may be a one-time access link where the link is only valid for a one-time use.

The method 700 may proceed to block 708 where the access link is provided. In an embodiment, at block 708, the access link may be provided to the client computing device 102a. The user of the client computing device 102a may then email, text, or otherwise communicate the access link to the user of the client computing device 102b, which in some cases may be the user of the client computing device 102a themselves. In other embodiments, the security engine 304 may provide the access link directly to the user of the client computing device 102b if the user of the client computing device 102a provided a communication medium (e.g., an email address or phone number) through which to send the access link to the user of the client computing device 102b.

The method 700 may proceed to block 710 where a use of the access link is received. In an embodiment, at block 710, the security engine 304 may receive a use of the access link. The user of the client computing device 102b may select the access link and this may cause the client computing device 102b to share its device identifier with the security engine 304. As such, the received use of the access link may include a device identifier of the client computing device 102b. In various embodiments, the user of the access link may cause the client computing device 102b to go through a user registration functionality within the security service computing device 104/300 to enable enrollment of the user and the client computing device 102b. During registration, the client computing device 102b may undergo authentication procedures utilizing FIDO protocols or other authentication protocols to establish secure authentication credentials, thereby bolstering authentication mechanisms. As such, the authentication credentials for the second user may be created and stored at the authentication computing device 106/400. For example, the private-public key pair may be created at the client computing device 102b such that the public key along with biometric or other user authentication information is sent to the authentication computing device 106/400.

The method 700 may proceed to block 712 where permission to access the content is granted to the guest client computing device. In an embodiment, at block 712, the security engine 304 may add the received device identifier of the client computing device 102a to a guest access table 308c of the content. In other embodiments, and returning to decision block 704, if the guest access request includes a user identifier of a register user of the security provider service, then the method 700 may proceed to block 712. As such, in block 712, the user identifier included in the guest access request may be added to the guest access table 308c. The user identifier may be associated with one or more device identifiers that may also be added to the guest access table 308c.

The method 700 may proceed to method 600 where a request to access the content from the second client computing device is received at block 602 and so on. In an embodiment, at block 602, the security engine 304 may receive the request to obtain the content. The request may be in the form of the access link selection and detection or as a separate request by the client computing device 102b as described above. The security engine 304 may perform the steps of method 600 for the client computing device 102b by checking the guest access table 308c as well as the access table 308b. As such, the security engine 304 may verify the user of the client computing device 102b, obtain the content identified in the request, authenticate the user and the client computing device 102b with the authentication computing device 106/400 (e.g., via FIDO authentication), and provide the content to the client computing device 102b for access. In some embodiments, the content may be made available for one-time use or duration of time. As such, the guest access table may include a time entry at which time access was granted to the content such that when a predetermined time condition, use condition, or other condition exists, the security engine 304 will remove the user identifier or device identifier of the client computing device 102b from the guest access table.

FIG. 8A illustrates an example flow diagram 800 of method 600 of FIG. 6 and method 700 of FIG. 7. At step 802, the user via the client computing device 102a may request access to content such as an email and its attachments via the security provider computing device 104. At step 804, the security provider computing device 104 may check user credentials of the user or client computing device to determine whether a secure access table indicates the user has permission to access the content. If the user has permission to access the content, at step 806, the security provider computing device 104 may request the content from the content provider computing device 108. The content provider computing device 108 may return the content to the security provider computing device 104, at step 808. Then the security provider computing device 104 may authenticate the user and the client computing device 102a with the authentication computing device 106, at step 810. The authentication may be performed using FIDO where a private key at the client computing device 102a signs a challenge provided with the content or by the security provider computing device that is then verified by a public key of the private key at the authentication computing device 106. At step 812, the authentication computing device 106 returns the authentication results to the security provider computing device 104. If the authentication results indicate an authentication of the client computing device 102a or the user, then, at step 814, the security provider computing device 104 may provide access to the content by the client computing device 102a.

In some embodiments, the user of the client computing device 102a may want to permit a guest to have access to the content at the client computing device 102b or may want to access content the client computing device 102b themselves. As such, at step 816, the user via the client computing device 102b may request guest access to the content with the security provider computing device 104/300 (e.g., via a security provider computing device application on the client computing device 102a). At step 818, the security provider computing device 104/300 may generate a guest access link. The access link may be a one-time guest access link. At step 820, the security provider computing device 104 may provide the guest access link to the client computing device 102a such that the user of the client computing device 102a may send the guest access link to the client computing device 102b. Though in some instances, the user may have provided communication details of the client computing device 102b in the guest access request and the security provider computing device 104 may provide the guest access link to the client computing device 102b directly. At step 822, the user of the client computing device 102b may use the guest access link, which may cause the client computing device 102b to register with the security provider computing device 104 and establish the authentication mechanism (e.g., generation of private and public key pairs for FIDO and biometric mapping). At step 824, the client computing device 102b and the user of the client computing device 102b may be validated. At step 826, the client computing device 102b and the user of the client computing device 102b may be authenticated with the authentication protocol (e.g., FIDO), and, at step 828, access may be granted to the content such that the client computing device 102b may access the content if the authentication is approved.

Referring now to FIG. 8B, illustrates an example entity relationship diagram 850 of the associations provided by the security provider computing device 104/300. FIG. 8B illustrates how the security provider computing device 104/300 may create a system to manage content access permissions effectively. This system empowers the primary user to add or remove additional users, authenticate new users, and specify access levels for each user, thereby enhancing control over content accessibility as well as the flexibility to map either content provider or individual content.

In FIG. 8B the content identifier in the content table 308d may be attached or tagged with a user identifier, device identifier, device type and user biometrics from the user table 308a. From the authentication computing device 106/400, user biometric details at device level are mapped before accessing a content. So, if a content identifier is tagged for security then no other related content will not open (e.g., an email and its attachment), until primary user unlock his client computing device 102a or if it's already unlocked then security engine 304 may map the biometric call of last login with authentication protocol stored biometric parameters. Once this is done, the security engine 304 will check in secure access table 308b to map user logged-in with content provider of the source provider table 308e or content identifier of the content table 308d.

In case user wants to access the document from someone else's mobile device then they need to ask the user identifier of other person and add that to guest access table 308c. The guest access table 308c may allow the guest access user to open the content one time, post which it will remove other user entry from guest access table 308c. If the secondary user is not using this security engine 304, then the primary user may select a one-time access link, and the security engine 304 may generate a link which can be shared to secondary user over email. Once secondary user selects this link, the selection is interpreted as a consent to send the secondary user's device identifier to the security engine 304, and the selection may add the secondary user device details in the guest access table 308c. In some embodiments, any entry in guest access table 308c may not live more than a predetermined time period or a predetermined number of times content is accessed, whichever is earlier.

In various embodiments of the present disclosure, the content's legitimacy may increase as more verified entities (e.g., users, tenants) access the content using authentication protocol (e.g., FIDO). Each interaction with the content by a certified user contributes to a cumulative “authenticity score.” The more certifying entities (e.g., trusted institutions or verified users) that access and authenticate the content, the higher the confidence in its legitimacy. This helps future users trust the content without needing additional verification, reducing redundancy in checking the content's authenticity. During methods 600 or 700, the security engine 304 may log every access event and any interaction with content. These access logs 312 may be stored by the security provider computing device 104/300 and may be stored in an immutable, cryptographically secure manner. The access logs 312 may track access information such as, for example, a duration of content access, a user or entity identifier, device information (e.g., device identifier, device type, or other device information) used for access, or authentication event details (e.g., via authentication protocol private keys). These immutable logs enhance transparency by providing a tamper-proof record of content access. Over time, as the content continues to be accessed by legitimate and verified users, the security engine 304 can generate a trust score or authenticity score, reflecting how well-certified the document is. The more high-trust users that have interacted with the document, the higher its score becomes, helping reduce the need for future verification.

In some embodiments, specific users/entities with certifying authority (e.g., legal firms, financial institutions, or regulatory bodies) can serve as validators. Their access to the content may boost its credibility and authenticity in the eyes of future users. These entities may also contribute to the trust score, allowing other users to gauge the content's legitimacy based on who has accessed or validated it. Each content may be assigned an authenticity score, which evolves as more certified entities access it. The score may be calculated based on: the number of access events, the certification level of the users/entities accessing the content, or the recency and frequency of access. Future users may view the score to determine the content's trustworthiness and avoid unnecessary verification processes.

The following example illustrates the methods and systems herein when sharing a secure financial document. In this example, an insurance company sends a monthly premium receipt to a customer via email. In the past, such emails had static passwords (e.g., the last four digits of the customer's card number), which could be easily exploited. To enhance security, the company now uses methods of the present disclosure such as FIDO authentication with document-level private key mapping.

Initially the customer may access the document according to method 600. The insurance company emails the receipt to the customer. The receipt document is protected by FIDO authentication. The customer accesses the receipt using their device (e.g., the client computing device 102a). The device-level private key at the client computing device 102a is mapped to the document, and the user's biometric data is verified using FIDO. This interaction is logged immutably by the security engine 304 in the access logs 312.

Next, in some embodiments, the document may be shared with a certifying entity (e.g., insurance agent). The customer may need the receipt verified by their insurance agent, who is a trusted, certified entity in the system. The customer grants the agent access via a guest access FIDO-authenticated link as in method 700. The agent also verifies their identity through FIDO, and their access event is logged in the access logs 312 by the security engine 304. As the insurance agent is a certifying entity, this access adds credibility to the document. The document's authenticity score increases.

Next, the customer may share the same document with their bank for a loan application and with their legal advisor for compliance purposes. Both parties may access the document using methods 600 or 700 described above, ensuring their device and biometrics are validated. Each access event is immutably logged in the access logs 312, adding to the transparency of the document's history.

As multiple certified entities (insurance agent, bank, legal advisor) access the document, the security engine 304 increases the authenticity score. This score is visible to future users, indicating that trusted entities have already accessed and verified the document. In the future, any additional users (such as a new financial institution) can quickly assess the document's legitimacy by checking the authenticity score. Since multiple high-trust entities have interacted with the document, there's no need for further verification, saving time and resources. If an audit is needed later, every interaction with the document is traceable. The immutable access logs show when, where, and how the document was accessed, including which device was used and whether FIDO authentication was successful. These logs ensure that the document has not been tampered with and provide cryptographic proof of every access event. The authenticity score builds over time as the document is shared with trusted entities, increasing its legitimacy. Certifying entities (e.g., the insurance agent, bank, legal advisor) boost the document's credibility by their access. The access logs 312 may be immutable and provide an auditable trail of interactions, proving the document's integrity at every stage. As such, future users can rely on the document's history and avoid unnecessary additional checks, making the entire process more efficient.

In another embodiment of the present disclosure, offline document access with deferred authentication may be possible. The offline document access may allow users to temporarily access authentication protocol-signed (FIDO-signed) content in environments with limited or no connectivity while still maintaining security. Because one objective of the present disclosure is to avoid letting unauthorized people access content, embodiments herein may implement features like preventing the PII/PCI data while the content is being viewed offline. If that data is needed to be viewed, the user would need to connect back to the network 110 to perform the authentication.

For example, in scenarios where a user needs to access a document without immediate internet connectivity (e.g., during travel, in remote areas, or within secure, network-restricted environments), the systems and methods of the present disclosure may grant limited, temporary access. Users can view the document offline, but full functionality—such as editing, sharing, or printing—remains restricted. As such, a portion of the access rights to the document may be granted to prevent certain actions from being taken with the document. In various embodiments, the offline access may be contingent upon deferred authentication (e.g., FIDO authentication). Once the device reconnects to the network 110, the user must complete an authentication check with their client computing device. This ensures that while the document is accessible offline, any sensitive actions require verification when the device regains connectivity. If authentication is not successfully completed within a designated time frame, the document locks and access is revoked. Even while offline, the document access is logged cryptographically within the security provider's application installed on the client computing device 102a, ensuring that all offline interactions can be validated upon reconnection. When the user computing devices 102 comes back online, these actions are tied to a FIDO authentication event, which records the user's device ID, biometrics, and other security details to ensure proper authorization.

While offline, users may be permitted to make minor edits or annotations to the document, but these changes will not be finalized or saved until the authentication is completed upon reconnection. This prevents unauthorized users from making significant changes to the document without proper authentication. This deferred authentication model offers users the flexibility to access critical content in situations where network access is intermittent or unreliable, without compromising content security. It's particularly useful for industries such as healthcare, field services, or government where secure content access is often required in offline or constrained environments.

In a particular example, a doctor works as a healthcare provider for a medical NGO operating in remote regions where internet connectivity is often unreliable or non-existent. During a field visit to a rural area, the needs access to a patient's medical records stored in a secure document management system that employs FIDO-based authentication for secure access according to method 600 above. Before traveling, the doctor downloads the patient's medical file to her tablet. Since internet connectivity is unreliable in the region, she relies on the security provider's offline access feature, which allows her to view the document while in the field, but she cannot edit, print, or share the file until the device is reconnected and authenticated via the authentication protocol. While the doctor is offline, she can view the patient's record, check their medical history, and make notes or annotations for later. However, the security provider computing device 104 or the security provider's native application 204b may temporarily lock advanced functionalities (like editing, signing prescriptions, or sharing files with other doctors) until the client computing device 102a is back online and a FIDO authentication is completed.

After returning to an area with internet connectivity, the client computing device 102a of the doctor may automatically attempts to reauthenticate with the authentication computing device 106. The doctor may use her fingerprint (biometric authentication) to complete the authentication process. Upon successful authentication, all the changes she made while offline are processed and saved. The security engine 304 also logs her activity in an activity log 314 during the offline session, linking her FIDO credentials to every interaction she had with the document. Upon reauthentication, the security engine 304 also updates the access logs 312 for the document with cryptographic proof of the doctor's offline access, including the device (e.g., the client computing device 102a) she used and her actions. This ensures that even though she accessed the document without real-time internet, all actions are securely logged and tied to her FIDO authentication once the connection is restored.

Various benefits may be realized by this offline access of content. The doctor may work efficiently in remote areas without sacrificing patient care due to connectivity issues. Furthermore, the deferred FIDO authentication ensures that the content's integrity and security are maintained even when full functionality is deferred. Further still, the system provides an immutable log of document access, ensuring that security is not compromised during the offline period.

Thus, systems and methods of the present disclosure provide secure content access using an authentication protocol that includes device-level private keys and biometric user authentication to access the document and log access with the document to provide an authenticity score with the document. Guest access may also be granted to the document that may be temporary in nature and access to users that are not registered with the security service that performs the verification and authentication process. As such, more secure content is realized preventing unauthorized use of content and exposure to sensitive information to unwanted users.

FIG. 9 illustrates an example of a computer system 900 that may be implemented by devices illustrated in FIG. 1. The computer system 900 may be part of or include the content authentication system 100 to perform the functions and features described herein. For example, various ones of the devices of content authentication system 100 may be implemented based on some or all of the computer system 900. The computer system 900 may include, among other things, an interconnect 910, a processor 912, a multimedia adapter 914, a network interface 916, a system memory 918, and a storage adapter 920.

The interconnect 910 may interconnect various subsystems, elements, and/or components of the computer system 900. As shown, the interconnect 910 may be an abstraction that may represent any one or more separate physical buses, point-to-point connections, or both, connected by appropriate bridges, adapters, or controllers. In some examples, the interconnect 910 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 910 may allow data communication between the processor 912 and system memory 918, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 912 may control operations of the computer system 900. In some examples, the processor 912 may do so by executing instructions such as software or firmware stored in system memory 918 or other data via the storage adapter 920. In some examples, the processor 912 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 914 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 916 may provide the computer system 900 with an ability to communicate with a variety of remote devices over a network. The network interface 916 may include, for example, an Ethernet adapter, a Fibre Channel adapter, and/or other wired-or wireless-enabled adapter. The network interface 916 may provide a direct or indirect connection from one network element to another, and facilitate communication to and between various network elements. The storage adapter 920 may connect to a standard computer readable medium for storage and/or retrieval of information, such as a fixed disk drive (internal or external).

Other devices, components, elements, or subsystems (not illustrated) may be connected in a similar manner to the interconnect 910 or via a network. The devices and subsystems can be interconnected in different ways from that shown in FIG. 6. Instructions to implement various examples and implementations described herein may be stored in computer-readable storage media such as one or more of system memory 918 or other storage. Instructions to implement the present disclosure may also be received via one or more interfaces and stored in memory. The operating system provided on computer system 900 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as 105) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A tangible, non-transitory, machine-readable medium storing instructions that when
executed by one or more processors effectuate operations comprising:
receiving, by one or more processors and from a first client computing device, a content request for content provided by a content provider computing device;
in response to determining that a user credential of a first user of the first client computing device associated with the content request is valid, obtaining, by one or more processors, the content identified in the content request from the content provider computing device;
authenticating, by one or more processors, the first client computing device and first authentication information associated with the first user via an authentication computing device; and
in response to the first client computing device and the first authentication information associated with the first user being valid, providing, by one or more processors, access to the content at the first client computing device.

2. The tangible, non-transitory, machine-readable medium of claim 1, wherein the operations further comprise:
receiving, by one or more processors, a guest access request for a second client computing device to access the content;
generating, by one or more processors, an access link and associating the second client computing device with the content;
providing, by one or more processors, the access link in response to the guest access request;
receiving, by one or more processors, an indication of use of the access link;
authenticating, by one or more processors, the second client computing device and second authentication information associated with a second user of the second client computing device via the authentication computing device; and
in response to the second client computing device and the second authentication information associated with the second user being valid, providing, by one or more processors, guest access to the content at the second client computing device.

3. The tangible, non-transitory, machine-readable medium of claim 2, wherein the operations further comprise:
removing, by one or more processors, the guest access to the content after a use condition or timeout condition is satisfied.

4. The tangible, non-transitory, machine-readable medium of claim 1, wherein the authenticating includes using a fast identity online (FIDO) authentication protocol.

5. The tangible, non-transitory, machine-readable medium of claim 1, wherein the operations further comprise:
registering, by one or more processors, the first user and the first client computing device to establish secure access credentials for the authenticating.

6. The tangible, non-transitory, machine-readable medium of claim 5, wherein the operations further comprise:
associating, by one or more processors, a device-level private key of the secure access credentials with the content by tethering the content to the device-level private key linked to the first client computing device.

7. The tangible, non-transitory, machine-readable medium of claim 5, wherein the operations further comprise:
receiving, by one or more processors, content access permissions for the content using the secure access credentials.

8. The tangible, non-transitory, machine-readable medium of claim 7, wherein the content access permissions include one or more additional users that are permitted to access the content and a level of access for each of the one or more additional users.

9. The tangible, non-transitory, machine-readable medium of claim 1, wherein the operations further comprise:
logging, by one or more processors, each access event to the content in an access log;
generating, by one or more processors and using the access log, an authenticity score; and
providing, by one or more processors, the authenticity score to the first user.

10. The tangible, non-transitory, machine-readable medium of claim 9, wherein the authenticity score is further based on at least one of a certification level of users accessing the content, a recency of access of the content, or a frequency of access of the content.

11. The tangible, non-transitory, machine-readable medium of claim 1, wherein the operations further comprise:
determining, by one or more processors and subsequent to obtaining the content, that the first client computing device does not have network connectivity to the authentication computing device;
providing, by one or more processors, partial access to the content at the first client computing device; and
performing, by one or more processors, the authenticating with the authentication computing device when the network connectivity is established.

12. A method, comprising:
receiving, by one or more processors and from a first client computing device, a content request for content provided by a content provider computing device;
in response to determining that a user credential of a first user of the first client computing device associated with the content request is valid, obtaining, by one or more processors, the content identified in the content request from the content provider computing device;
authenticating, by one or more processors, the first client computing device and first authentication information associated with the first user via an authentication computing device; and
in response to the first client computing device and the first authentication information associated with the first user being valid, providing, by one or more processors, access to the content at the first client computing device.

13. The method of claim 12, further comprising:
receiving, by one or more processors, a guest access request for a second client computing device to access the content;
generating, by one or more processors, an access link and associating the second client computing device with the content;
providing, by one or more processors, the access link in response to the guest access request;
receiving, by one or more processors, an indication of use of the access link;
authenticating, by one or more processors, the second client computing device and second authentication information associated with a second user of the second client computing device via the authentication computing device; and
in response to the second client computing device and the second authentication information associated with the second user being valid, providing, by one or more processors, guest access to the content at the second client computing device.

14. The method of claim 12, wherein the authenticating includes using a fast identity online (FIDO) authentication protocol.

15. The method of claim 12, further comprising:
registering, by one or more processors, the first user and the first client computing device to establish secure access credentials for the authenticating.

16. The method of claim 15, further comprising:
associating, by one or more processors, a device-level private key of the secure access credentials with the content by tethering the content to the device-level private key linked to the first client computing device.

17. The method of claim 12, further comprising:
logging, by one or more processors, each access event to the content in an access log;
generating, by one or more processors and using the access log, an authenticity score; and
providing, by one or more processors, the authenticity score to the first user.

18. The method of claim 12, further comprising:
determining, by one or more processors and subsequent to obtaining the content, that the first client computing device does not have network connectivity to the authentication computing device;
providing, by one or more processors, partial access to the content at the first client computing device; and
performing, by one or more processors, the authenticating with the authentication computing device when the network connectivity is established.

19. A system, comprising:
one or more processors; and memory storing instructions that when executed by the one or more processors cause the one or more processors to effectuate operations, including:
receiving, from a first client computing device, a content request for content provided by a content provider computing device;
in response to determining that a user credential of a first user of the first client computing device associated with the content request is valid, obtaining the content identified in the content request from the content provider computing device;
authenticating the first client computing device and first authentication information associated with the first user via an authentication computing device; and
in response to the first client computing device and the first authentication information associated with the first user being valid, providing access to the content at the first client computing device.

20. The system of claim 19, wherein the operations further comprise:
receiving a guest access request for a second client computing device to access the content;
generating an access link and associating the second client computing device with the content;
providing the access link in response to the guest access request;
receiving an indication of use of the access link;
authenticating the second client computing device and second authentication information associated with a second user of the second client computing device via the authentication computing device; and
in response to the second client computing device and the second authentication information associated with the second user being valid, providing guest access to the content at the second client computing device.
